(19) United States
(12) Patent Application Publication
(10) Pub. No.: US 2019/0289679 A1
(43) Pub. Date: Sep. 19, 2019

(54) Cooking Equipment For Induction Cooking On A Porcelain Surface

(71) Applicant: ARBE STOLANIC, S.L., Valencia (ES)

(72) Inventor: Ignacio RODRIGUEZ BENEYTO, Valencia (ES)

(21) Appl. No.: 16/211,270

(22) Filed: Dec. 6, 2018

(30) Foreign Application Priority Data
Mar. 13, 2018 (ES) U201830347

(51) Int. Cl. H05B 6/06; H05B 6/12

(52) U.S. Cl. CPC H05B 6/062; H05B 2213/06; H05B 6/1209

(57) ABSTRACT

Cooking equipment for induction cooking on a porcelain surface formed by induction means incorporated below a cooking surface connected to electrical and electronic operation and power control means, further comprising thermal insulating separators that are located between the cooking surface and the ferromagnetic surface of the vessel in which cooking is performed, as the electrical and electronic operation and power control means, a control unit for controlling the induction means, incorporated below the cooking surface, a remote control panel, and temperature sensors with at least one of them being incorporated in each of the thermal insulating separators, with communication means being provided so that the control unit receives information both from the remote control panel and from the temperature sensors located in the separators for regulating the power of the induction means.

### OBJECT OF THE INVENTION

As expressed in the title of the present specification, the invention relates to cooking equipment for induction cooking on a porcelain surface which provides the intended function thereof with novel features and advantages that will be described in detail below and entail an improvement of the current state of the art.

More specifically, the object of the invention focuses on cooking equipment for induction cooking on a porcelain surface characterized by comprising a control unit which regulates the power of the induction means located below the cooking surface, which communicates by means of radiofrequency both with the remote control panel located on the cooking surface through the set of buttons of which the temperature selection is performed, and with temperature sensors incorporated inside independent thermal insulating separators which can be coupled to the ferromagnetic surface of the vessel to be used for cooking in each case, and from which said control unit receives a signal for adjusting the selected temperature, preventing possible overheating of the vessel.

### FIELD OF APPLICATION OF THE INVENTION

The field of application of the present invention is comprised within the sector of the industry dedicated to the manufacture of household appliances, focusing particularly on the field of induction stoves.

### BACKGROUND OF THE INVENTION

Induction stoves or cooktops are well-known on the market. As is known, induction cooking works by directly heating the vessel with induction heating instead of transferring heat from electric coils or burning gas. To that end, it uses magnetic energy transfer (by means of magnetic coils) instead of flames or electrical elements to generate heat, these coils being installed below the cooking surface, which is usually a ceramic surface and can be formed by one or more layers of different material, and the vessels to be used for cooking must have a lower ferromagnetic surface.

Furthermore, to prevent overheating problems, some systems incorporating separators that act as thermal insulators between the cooking surface and the ferromagnetic surface of the vessel are known.

In that sense, patent document ES 2 427 422 B1 discloses an “Induction cooking system and induction equipment required for said system” which seeks to drastically reduce the temperature of the cooking surface during cooking, which system comprises induction equipment which houses electrical and electronic means below a casing of a single area, at least an induction coil, spacer elements or separators between the induction coils and the lower face of the cooking surface, internal heat evacuation means which can be fans, and on the other hand a silicone part or the like which is placed between the base of a cooking element and the cooking surface.

Likewise, patent document ES2402960B1 discloses an “Induction cooking system and vessel required for said system” which contemplates the use of spacing means to prevent heat transfer from the base of the vessel to the cooking surface, which means are arranged between the ferromagnetic base of the vessel and the cooking surface, and are capable of withstanding temperatures that the ferromagnetic bases of the vessels reach during cooking. Specifically, said spacing means are studs distributed on the base of the vessel which can form an integral part thereof emerging from its base, or can be fixed thereto by means of glues or adhesives or by mechanical means, said studs being made of one or more materials that withstand high temperatures, such as infusible and insoluble thermoplastic polymers which are thermosetting materials that become plastic, deformable, or flexible at relatively high temperatures, such as silicone, elastomers, and composite materials.

The objective of the present invention is to go one step further in controlling the temperature of the ferromagnetic cooking surface to prevent possible overheating of said surface because even though the existing separator elements help, they are not an optimum solution given that they are only passive safety elements that slightly separate the vessel from the cooking surface, whereas the solution proposed by the present invention consists of the inclusion of active safety elements which, when suitably linked to the control electronics of the induction means, allow dynamic temperature control depending on the possible variation thereof at all times, which greatly increases the effectiveness of the cooking system with respect to what is known today.

In this sense, as a reference to the current state of the art, it can be pointed out that even though there is other cooking equipment for induction cooking on a porcelain surface, the applicant is nonetheless unaware of the existence of any such equipment or of any other invention with a similar application having technical, structural, and constitutive features that are identical or similar to the features herein proposed and claimed.

### DESCRIPTION OF THE INVENTION

The cooking equipment for induction cooking on a porcelain surface proposed by the invention is therefore configured as a novelty within its field of application, since the objectives indicated above are specifically and satisfactorily achieved according to its implementation, with the characterizing details which make it possible and distinguish it being conveniently included in the final claims accompanying the present description.

More specifically, as indicated above, the invention proposes cooking equipment for induction cooking which is distinguished by having a control unit that regulates the power of the induction means located below the cooking surface, receives radiofrequency signals both from a remote control panel located on the cooking surface, through the set of buttons of which temperature selection is performed, and from temperature sensors incorporated inside thermal insulating separators formed by independent elements that can be coupled to the ferromagnetic surface of the vessel to be used for cooking in each case.

The equipment thereby allows adjusting the cooking temperature at all times as a result of the feedback provided by the sensor of the thermal insulating separators and the corresponding actuation of the control unit. This allows preventing the vessel from becoming overheated due to a large amount of power.

The following must be highlighted with respect to the details of the main parts of the equipment:

In addition to thermally insulating the cooking surface to prevent heat transfer from the vessel to said surface, each thermal insulating separator with a temperature probe is intended for providing information about the temperature of the cooking vessel to the control unit of the induction at all times.

To that end, in the preferred embodiment the separator can furthermore be magnetically fixed to the ferromagnetic surface of any vessel that will be used, as a result of a permanent magnet housed therein.

Said permanent magnet is manufactured with the suitable substance so that the induction does not heat it up or the effect is minimal. This magnet allows fixing the separator anywhere on the ferromagnetic heating surface of any vessel that will be used in cooking. Several separators will be distributed over the surface of the vessel such that they assure uniform spacing with the cooking surface.

At the same time, the separator houses therein a series of components which allow measuring the temperature in the cooking vessel and transmitting it to the control unit of the induction equipment.

These components are:
A coil serving to pick up induction energy of the cooking surface and supplying the energy for separator operation.
A temperature sensor for the suitable range of temperatures covered by the cooking equipment with suitable tolerance so as not to become damage.
A radiofrequency (RF) communication module which sends the information with temperature readings to the control unit of the induction equipment.
An electronic control board which converts the signals of the sensor into temperature values and sends them to the communication module.

It is important to point out that all these components of the separator are coated with a thermal insulating material which assures their stability and prevents heat transfer from the cooking vessel to the cooking surface. Those technical properties providing thermal insulation, resistance to high temperatures, preventing combustion and deformation, can all be found in this material.

The remote control panel is in turn an element which is preferably located on the cooking surface and receives electric energy in order to work by means of an induction pickup element. Optionally, it can also have a backup battery.

In any case, the control panel has a display depicting the state of the cooking surface and the temperature in each of the different separators placed in the vessels, as well as other parameters such as timers, etc. Furthermore, it has a set of control buttons for selecting the temperature and other handling operations, which set of control buttons can be a set of touch buttons and can be integrated in the display, or it can be of another type, as long as the cleaning thereof is assured and as long as any spillage will not be able to cause any damage thereto. It also incorporates a radiofrequency (RF) communication module for the transmission and reception of information of the cooking surface, which will allow adjusting the cooking power to the desired temperature, all these components being connected to an electronic control board.

Finally, the control unit of the equipment, which is located below the cooking surface, is in charge of controlling the induction means based on the information received from the remote control panel and from the sensors of the thermal insulating separators. The control unit allows establishing a cooking temperature and assuring at all times that said temperature is reached in the vessel and stabilized, as well as assuring all the safety parameters to prevent any risk situation in the equipment.

To that end, said control unit comprises at least a power supply stage, an electronic control board, and a radiofrequency (RF) communication module.

Additionally, the control unit also includes a microprocessor with WiFi connection that stores a software whereby cooking, among other things, can be handled from any mobile device, both from a device with an Android system and from an iPhone, providing the equipment with the capacity to be integrated in the so-called Internet of Things, which allows the digital interconnection of objects, particularly household appliances, by means of the Internet, since it allows handling and managing the cooking equipment using other programmable equipment, as if they were humans.

The described cooking equipment for induction cooking on a porcelain surface therefore represents an innovation having structural and constitutive features that were unknown up until now, and these reasons, combined with its practical usefulness, give the invention sufficient grounds for obtaining the exclusive right that is sought.

### DESCRIPTION OF THE DRAWINGS

To complement the description that is being made and for the purpose of aiding to better understand the features of the invention, a set of drawings is attached to the present specification as an integral part thereof in which the following has been depicted in an illustrative and non-limiting character:

FIG. 1 shows a partially sectioned perspective view of an example of the cooking equipment object of the invention, its general configuration and the main parts it comprises being shown.

FIG. 2 shows, by means of a block diagram, a schematic depiction of the elements comprised in the thermal insulating separators.

FIG. 3 shows, by means of a block diagram, a schematic depiction of the elements comprised in the remote control panel with the set of buttons for selecting the temperature and handling the equipment.

FIG. 4 shows, by means of a block diagram, a schematic depiction of the elements comprised in the control unit located below the cooking surface, depicted next to the induction means the power of which it regulates.

### PREFERRED EMBODIMENT OF THE INVENTION

In view of the mentioned drawings a non-limiting embodiment of the cooking equipment for induction cooking on a porcelain surface of the invention can be seen therein, which equipment comprises the parts and elements that are indicated and described in detail below according to the numbering adopted according to the following list:
1. equipment
2. induction means
3. cooking surface
4. separators
5. ferromagnetic surface
6. control unit
7. remote control panel
8. temperature sensors
9. permanent magnet
10. inductive pickup coil
11. communication module
12. electronic control board
13. thermal insulating layer
14. display
15. set of control buttons
16. backup battery
17. power supply stage

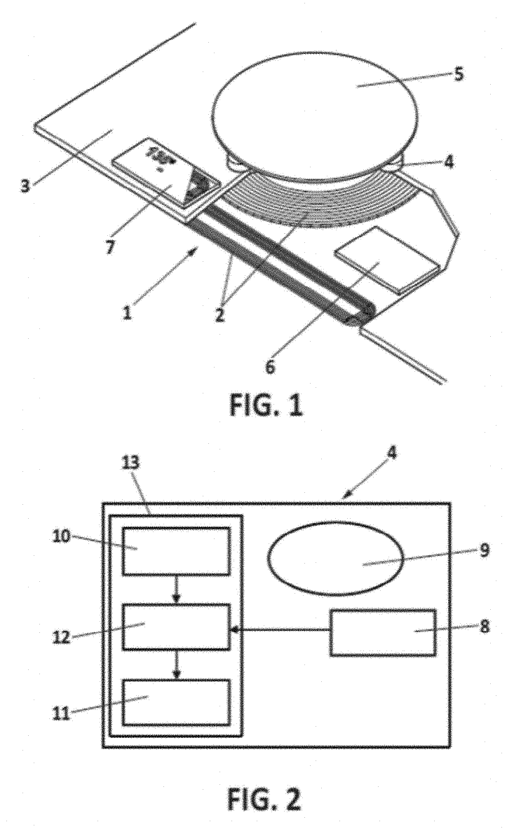

In this sense, as seen in FIG. 1 the equipment (1) in question is essentially configured, as is known, from induction means (2) incorporated below a cooking surface (3) connected to electrical and electronic operation and power control means, further comprising thermal insulating separators (4) that are located between the cooking surface (3) and the ferromagnetic surface (5) of the vessel in which cooking is performed, and is distinguished by the fact that the equipment (1) comprises, as the electrical and electronic operation and power control means, a control unit (6) for controlling the induction means (2), incorporated below the cooking surface (3), a remote control panel (7), preferably incorporated on the cooking surface (3), and temperature sensors (8), with at least one of them being incorporated in each of the thermal insulating separators (4) that are located between the cooking surface (3) and the ferromagnetic surface (5) of the vessel to be used, with communication means being provided so that the control unit (6) receives information both from the remote control panel (7) and from the temperature sensors (8) located in the separators (4) for regulating the power of the induction means (2).

Furthermore, each separator (4) preferably incorporates a permanent magnet (9) housed therein which allows magnetically fixing it at will to the ferromagnetic surface (5) of the cooking vessel.

Considering the depiction of FIG. 2, it can be seen how, in addition to said permanent magnet (9) and the temperature sensor (8), for its operation and for transmitting information to the control unit (6), each separator (4) also incorporates an inductive pickup coil (10) for picking up the energy of the cooking surface (3) which supplies said energy for the operation of the separator (4), a radiofrequency (RF) communication module (11) which sends the information with temperature readings to the control unit (7), and an electronic control board (12) which converts the signals of the sensor (8) into temperature values and sends them to the communication module (11).

Preferably, these components of the separator (4), i.e., the inductive pickup coil (10), the communication module (11), and the electronic control board (12) are coated with a thermal insulating layer (13) made of a high temperature-resistant material, preventing their combustion and deformation.

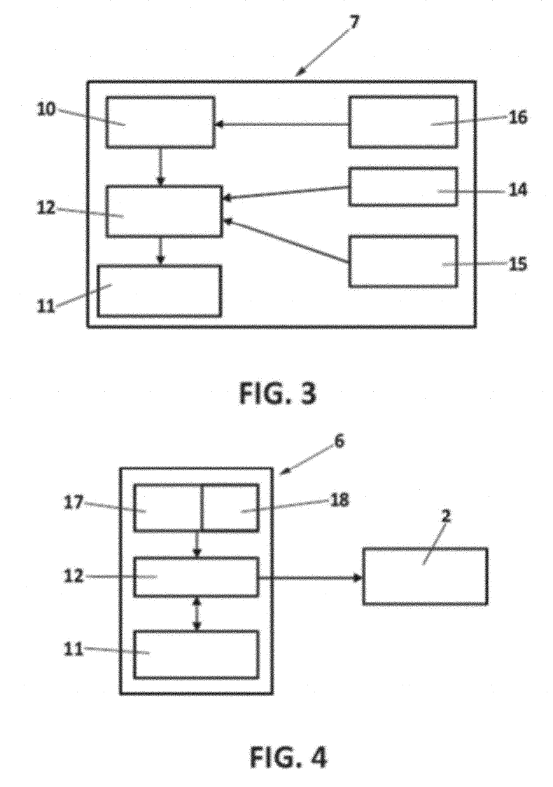

In turn, in the depiction of FIG. 3 it can be seen how, in addition to also incorporating an inductive pickup coil (10) for obtaining energy for operation, a radiofrequency (RF) communication module (11) for the transmission and reception of information of the cooking surface, and an electronic control board (12), the remote control panel (7) has a display (14) for showing the state of the cooking surface (3) and the temperature of each of the separators (4) that has been placed on the ferromagnetic surface (5) of one or more vessels, as well as other parameters, and a set of control buttons (15) for selecting temperatures and other handling operations.

Said set of control buttons (15) is preferably a set of touch buttons, and it is integrated in the display (14) itself, the display being a touch screen, even though this does not entail any limitation.

Furthermore, the remote control panel (7) furthermore optionally has a backup battery (16).

Finally, the diagram of FIG. 4 shows the components of the control unit (6) of the equipment which is located below the cooking surface (3) and controls the induction means (2), said control unit (7) comprising at least a power supply stage (17), an electronic control board (12), and a radiofrequency (RF) communication module (11).

Additionally, in another embodiment variant of the equipment (1), the control unit (6) also includes a microprocessor (18) with WiFi connection the software of which allows, among other things, handling said equipment (1) from any mobile device through the Internet, and therefore handling the digital interconnection thereof in the Internet of Things.

Having sufficiently described the nature of the present invention as well as the way of putting it into practice, it is not considered necessary to further describe the invention so that a person skilled in the art can comprehend the scope thereof and the advantages derived from it, stating that within its essential nature, the present invention could be carried out to practice in other embodiments differing in detail from that indicated by way of example, and such embodiments would also be granted the protection that is sought provided that the fundamental principle thereof is not altered, changed or modified.

1. Cooking equipment for induction cooking on a porcelain surface formed by induction means (2) incorporated below a cooking surface (3) connected to electrical and electronic operation and power control means, further comprising thermal insulating separators (4) that are located between the cooking surface (3) and the ferromagnetic surface (5) of the vessel in which cooking is performed, characterized by comprising, as the electrical and electronic operation and power control means, a control unit (6) for controlling the induction means (2), incorporated below the cooking surface (3), a remote control panel (7), and temperature sensors (8) with at least one of them being incorporated in each of the thermal insulating separators (4), with communication means being provided so that the control unit (6) receives information both from the remote control panel (7) and from the temperature sensors (8) located in the separators (4) for regulating the power of the induction means (2).

2. Cooking equipment for induction cooking on a porcelain surface according to claim 1, characterized in that the remote control panel (7) is incorporated on the cooking surface (3).

3. Cooking equipment for induction cooking on a porcelain surface according to claim 1, characterized in that each separator (4) incorporates a permanent magnet (9) housed therein which allows magnetically fixing it at will to the ferromagnetic surface (5) of the cooking vessel.

4. Cooking equipment for induction cooking on a porcelain surface according to claim 3, characterized in that in addition to the temperature sensor (8) and the permanent magnet (9), each separator (4) also incorporates an inductive pickup coil (10) for picking up the energy of the cooking surface (3) which supplies said energy for the operation of the separator (4), a radiofrequency (RF) communication module (11) which sends the information with temperature readings to the control unit (7), and an electronic control board (12) which converts the signals of the sensor (8) into temperature values and sends them to the communication module (11)

5. Cooking equipment for induction cooking on a porcelain surface according to claim 4, characterized in that the inductive pickup coil (10), the communication module (11), and the electronic control board (12) of the separator (4) are coated with a thermal insulating layer (13) made of a high temperature-resistant material, preventing their combustion and deformation.

6. Cooking equipment for induction cooking on a porcelain surface according to claim 4, characterized in that in addition to the inductive pickup coil (10) for obtaining energy for operation, a radiofrequency (RF) communication module (11) for the transmission and reception of information of the cooking surface, and an electronic control board (12), the remote control panel (7) has a display (14) for showing the state of the cooking surface (3) and the temperature of each of the separators (4) that has been placed on the ferromagnetic surface (5) of one or more vessels, as well as other parameters, and a set of control buttons (15) for selecting temperatures and other handling operations.

7. Cooking equipment for induction cooking on a porcelain surface according to claim 6, characterized in that the set of control buttons (15) is a set of touch buttons, and it is integrated in the display (14) itself, the display being a touch screen.

8. Cooking equipment for induction cooking on a porcelain surface according to claim 6, characterized in that the remote control panel (7) furthermore has a backup battery (16).

9. Cooking equipment for induction cooking on a porcelain surface according to claim 4, characterized in that the control unit (6) which is located below the cooking surface (3) and controls the induction means (2) comprises a power supply stage (17), an electronic control board (12), and a radiofrequency (RF) communication module (11).

10. Cooking equipment for induction cooking on a porcelain surface according to claim 9, characterized in that the control unit (6) further includes a microprocessor (18) with WiFi connection the software of which allows, among other things, handling said equipment (1) from any mobile device through the Internet.
